(19) United States
(12) Patent Application Publication
(10) Pub. No.: US 2011/0197043 A1
(43) Pub. Date: Aug. 11, 2011

(54) METHOD FOR ADJUSTING PERFORMANCE OF SYSTEM MEMORY AND COMPUTER SYSTEM THEREOF

(75) Inventor: Tien-Jui Lin, Taipei (TW)

(73) Assignee: ASUSTEK COMPUTER INC., Taipei (TW)

(21) Appl. No.: 13/025,169

(22) Filed: Feb. 11, 2011

(30) Foreign Application Priority Data
Feb. 11, 2010 (TW) 99104439

(51) Int. Cl. G06F 12/14

(52) U.S. Cl. 711/163; 711/E12.091

(57) ABSTRACT

A method for adjusting performance of a system memory used in a computer system with a system memory includes the following steps: in an operating system in operating, preventing the computer system from accessing data of the system memory when an event is triggered; giving a memory control command to execute a performance adjust program of the system memory after the computer system is completely prevented from accessing the data of the system memory; and permitting accessing the data of the system memory after the performance adjust program is completed.

### CROSS-REFERENCE TO RELATED APPLICATION

This application claims the priority benefit of Taiwan application Ser. No. 99104439, filed on Feb. 11, 2010. The entirety of the above-mentioned patent application is hereby incorporated by reference herein and made a part of this specification.

### BACKGROUND OF THE INVENTION

1. Field of the Invention

The invention relates to a method for adjusting performance of a system memory and a computer system thereof.

2. Description of the Related Art

With the popularity of a personal computer (PC), the application of relating software increases greatly. To improve the efficiency, many users change the frequency to improve the performance or save power without changing the hardware device. Changing frequency means changing the operating frequency of a central processing unit (CPU), and then the CPU works stably under a frequency different from a rated frequency. However, the system cannot work at a converted frequency efficiently and steadily only by changing the operating frequency of the CPU. The parameters of a system memory and other relating hardware also need to be adjusted.

Most of early motherboards use a jumper or a dual in-line package (DIP) switch to convert the frequency of the CPU and the system memory. Thus, the users have to change jumper setting at the motherboard. That is, if the user wants to set the frequency conversion of the computer system, he or she has to open the computer casing and use tools, which is rather inconvenient.

Afterwards, an operating interface of a basic input output system (BIOS) is developed for setting the frequency conversion. In the method, the user should select entering the operating interface of the BIOS when booting, and set relating parameters. When using the method to set the frequency conversion, the parameter setting is rather complicated, and every time the user sets the parameters, the computer needs to reboot to reload the BIOS and the operating system, which consumes too much time.

In sum, the conventional method for frequency conversion is inefficient, and the user needs to wait for a long time.

### BRIEF SUMMARY OF THE INVENTION

A method for adjusting performance of a system memory used in a computer system of a system memory is provided. The method includes the following steps: in an operating system in operating, preventing the computer system from accessing data of the system memory when an event is triggered; giving a memory control command to perform a performance adjust program of the system memory after the computer system is completely prevented from accessing the data of the system memory; and permitting accessing the data of the system memory after the performance adjust program is completed.

In an embodiment of a method for adjusting performance of a system memory, the event is a frequency conversion event. The user triggers the frequency conversion event via an operating interface of an application program to input a frequency conversion command, or via a button, a knob or a touch device of a hardware device. The frequency conversion event is used for setting the operating frequency of a CPU of the computer system and a memory controller.

A computer system includes a system memory, a non-volatile memory, an operating system stored in the non-volatile memory and a control program stored in the non-volatile memory. After the control program prevents the computer system from accessing data of the system memory according to an event triggered, a performance adjust program of the system memory is executed, and after the performance adjust program is completed, the data accessing of the system memory is restored.

These and other features, aspects and advantages of the present invention will become better understood with regard to the following description, appended claims, and accompanying drawings.

### BRIEF DESCRIPTION OF THE DRAWINGS

FIG. 1 is a block diagram showing a computer system in an embodiment of the invention;

FIG. 2 is a flowchart showing a method for adjusting performance of a system memory in a first embodiment of the invention; and

FIG. 3 is a flowchart showing a method for adjusting performance of a system memory in a second embodiment of the invention.

### DETAILED DESCRIPTION OF THE EMBODIMENTS

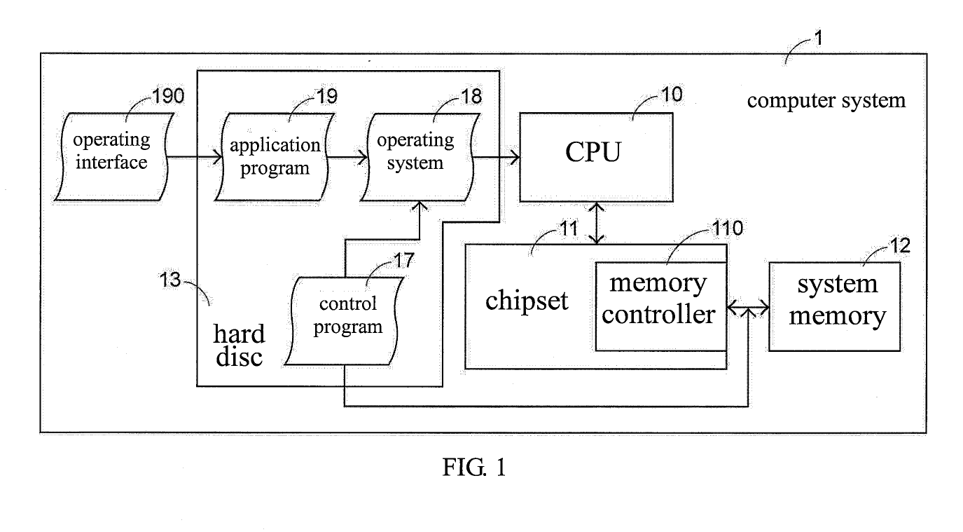

A method for adjusting performance of a system memory is provided, which may be used in a computer system in FIG. 1. FIG. 1 is a block diagram showing a computer system in an embodiment of the invention. A computer system 1 includes a CPU 10. The CPU 10 controls a memory controller 110 of a chipset 11 to access data of a system memory 12. To facilitate the user setting the frequency conversion of the system, an application program 19 is provided. The application program 19 and an operating system 18 may be stored in a non-volatile memory of the computer system, such as a hard disc 13 as shown in FIG. 1. The application program 19 operates in the computer system 1 with the operating system 18, and an operating interface 190 is used for enabling the application program 19. The operating interface 190 may be a graphical user interface (GUI) displayed at a display or a physical button disposed at a computer panel. When the user enables the application program 19 via the operating interface 190 to input a frequency conversion command, the application program 19 sets the operating frequency of the CPU 10 to finish the frequency conversion setting of the CPU 10.

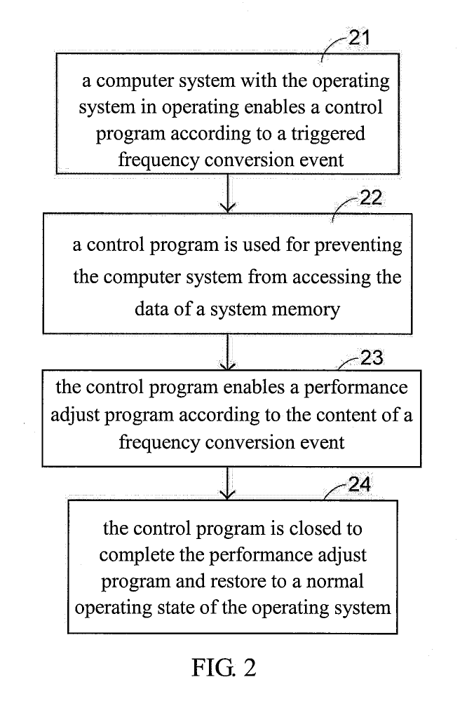

However, when the frequency conversion of the CPU 10 is set, if the system memory 12 has other access actions at the same time, the relating frequency conversion setting or the accuracy of the data accessing of the system memory 12 is affected. To ensure that the data stored in the system memory 12 would not have an error due to the frequency conversion setting, a control program 17 is used to perform a method for adjusting performance of a system memory as shown in FIG. 2. FIG. 2 is a flowchart showing a method for adjusting performance of a system memory in a first embodiment of the invention. The control program 17 may be stored in the hard disc 13. The computer system 1 with the operating system 18 in operating enables the control program 17 (Step 21) according to a triggered frequency conversion event in the above system. The control program 17 is mainly used for preventing the computer system 1 from accessing the data of the system memory 12 (Step 22). It mainly prevents the CPU 10 from accessing the data of the system memory 12 via the memory controller 110 and prevents other peripheral hardware devices (not shown) from accessing the data of the system memory 12 via a direct memory access device (not shown). Thus, it ensures that the data stored in the system memory 12 would not have an error due to the frequency conversion setting. Then, in response to the content of the frequency conversion event, the control program 17 gives a memory control command to execute a performance adjust program (Step 23). For example, when the frequency conversion event adjusts the operating frequency of the CPU 10 from 2.8 GHz to 3.2 GHz, the control program 17 gives a command to set mode registers (MRS) according to the frequency conversion event to rewrite the parameters (such as an on-die termination (ODT), column address strobe latency (CAS latency), a burst transmission length, delay locked loop (DLL) reset) in 2.8 GHz to be the parameters in 3.2 GHz. The memory control commands include set ting mode registers, entering a self refresh state, exiting a self refresh state, entering a power down mode, exiting a power down mode, performing impedance calibration (ZQ) short, performing ZQ long, and performing a no operation (NOP) command. When the relating parameters setting is completed, the control program 17 is closed to complete the performance adjust program, the normal operating system restores (Step 24), and then the data of the system memory 12 can be accessed.

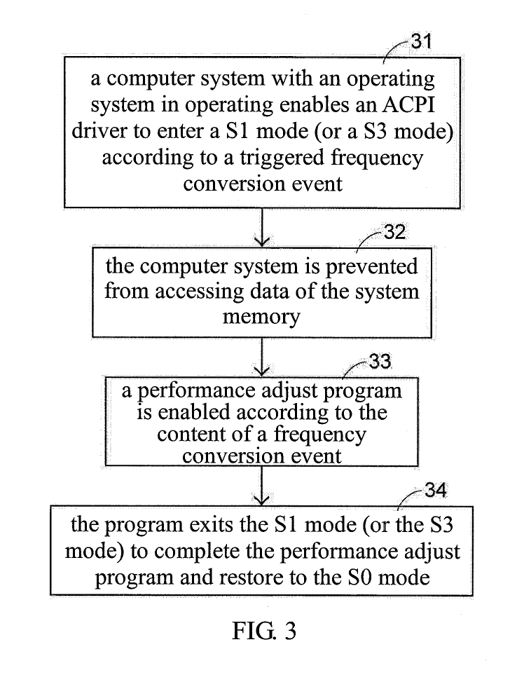

The content executed by the above control program 17 may be achieved by a power management driver of the operating system 18. For example, a driver conforming to the advanced configuration and power interface specification (ACPI Spec) makes the system enter a S1 mode or a S3 mode defined in the ACPI specification, and then the computer system 1 is prevented from accessing the data of the system memory 12. Consequently, the step of enabling the control program 17 in response to the triggered frequency conversion event may be replaced by entering the S1 mode or the S3 mode. A second embodiment of the method for adjusting performance of a system memory in FIG. 3 is developed.

First, the computer system 1 with the operating system 18 operating enables the ACPI driver to enter a S1 mode (or a S3 mode) in response to the triggered frequency conversion event (Step 31), and then the computer system 1 is prevented from accessing the data of the system memory 12 (Step 32). In this way, it ensures that the data stored in the system memory 12 would not have an error due to the frequency conversion setting. Second, the control program 17 only needs to give a memory control command in response to the content of the frequency conversion event to rewrite the relating parameters of the system memory to execute the performance adjust program (Step 33). For example, the frequency conversion event adjusts the operating frequency of the CPU 10 from 2.8 GHz to 3.2 GHz. Thus, the control program 17 gives a controlling command such as setting mode registers, entering a self refresh state, exiting a self refresh state, entering a power down mode, exiting a power down mode, performing ZQ short and performing ZQ long in response to the frequency conversion event to rewritten the parameters in 2.8 GHz to be the parameters in 3.2 GHz. Third, the operating system exits the S1 mode (or the S3 mode) to complete the performance adjust program and restore to the normal operating system working state such as the S0 mode (Step 34), and then the data of the system memory 12 can be accessed. As a result, the control program 17 does not need to be added additionally, and the S1 mode of the ACPI driver may be used directly. Furthermore, the time for entering and exiting the S1 mode is quite short.

The above frequency conversion event not only can be enabled by the user, but also can be enabled automatically according to the system load change of the computer system 1. Complicated frequency conversion process in the conventional method is saved.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method for adjusting performance of a system memory, used in a computer system with a system memory, the method comprising:
preventing the computer system from accessing data of the system memory when an event is triggered in an operating system in operating;
giving a memory control command to perform a performance adjust program of the system memory after the computer system is prevented from accessing the data of the system memory; and
permitting accessing the data of the system memory after the performance adjust program is completed.

2. The method for adjusting performance of a system memory according to claim 1, wherein the event is a frequency conversion event, and the frequency conversion event inputs a frequency conversion command via an operating interface to enable an application program to set an operating frequency of a central processing unit (CPU) of the computer system.

3. The method for adjusting performance of a system memory according to claim 1, wherein the event is a frequency conversion event, the frequency conversion event is triggered according to a system load change of the computer system, and the frequency conversion event is used for setting an operating frequency of a CPU of the computer system.

4. The method for adjusting performance of a system memory according to claim 1, wherein a control program stored in the computer system is used for preventing the computer system from accessing the data of the system memory.

5. The method for adjusting performance of a system memory according to claim 4, wherein the control program is used for preventing a CPU of the computer system from accessing the data of the system memory via a memory controller, and preventing a peripheral hardware device from accessing the data of the system memory.

6. The method for adjusting performance of a system memory according to claim 5, wherein the peripheral hardware device accesses the data of the system memory via a direct memory access device.

7. The method for adjusting performance of a system memory according to claim 4, wherein after the performance adjust program is completed, the control program is closed to permit accessing the data of the system memory.

8. The method for adjusting performance of a system memory according to claim 1, wherein a power management driver of the operating system prevents the computer system from accessing the data of the system memory.

9. The method for adjusting performance of a system memory according to claim 8, wherein the power management driver is a driver conforming to advanced configuration and power interface specification (ACPI Spec), and an action of preventing the computer system from accessing the data of the system memory is entering a S1 mode or a S3 mode defined by the ACPI Spec.

10. The method for adjusting performance of a system memory according to claim 9, wherein after the performance adjust program is completed, the S1 mode or the S3 mode defined by the ACPI Spec is transformed to a S0 mode to permit accessing the data of the system memory.

11. The method for adjusting performance of a system memory according to claim 1, wherein giving the memory control commands include setting a mode register, entering a self refresh state, exiting a self refresh state, entering a power down mode, exiting a power down mode, performing impedance calibration (ZQ) short, performing ZQ calibration long, and performing a no operation (NOP) command.

12. A computer system, comprising:
a system memory;
a non-volatile memory;
an operating system stored in the non-volatile memory; and
a control program stored in the non-volatile memory.
wherein in response to an event triggered, after the control program prevents the computer system from accessing data of the system memory, a performance adjust program of the system memory is enabled, and after the performance adjust program is completed, the data of the system memory is permitted to be accessed.

13. The computer system according to claim 12, wherein the event is a frequency conversion event and the frequency conversion event inputs a frequency conversion command via an operating interface of the computer system to enable an application program stored in the non-volatile memory to set an operating frequency of a CPU of the computer system.

14. The computer system according to claim 12, wherein the event is a frequency conversion event, the frequency conversion event is triggered according to a system load change of the computer system, and the frequency conversion event is used for setting an operating frequency of a CPU of the computer system.

15. The computer system according to claim 12, wherein a control program is used for preventing the computer system from accessing the data of the system memory to prevent a CPU of the computer system from using a memory controller to access the data of the system memory, and preventing a peripheral hardware device of the computer system from accessing the data of the system memory.

16. The computer system according to claim 15, wherein the peripheral hardware device uses a direct memory access device to access the data of the system memory.

17. The computer system according to claim 12, wherein performing the performance adjust program of the system memory includes sending a memory control command to the system memory and then executing the performance adjust program.

18. The computer system according to claim 17, wherein the memory control commands include setting a mode register, entering a self refresh, exiting a self refresh, entering a power down, exiting a power down, performing ZQ calibration short, performing ZQ calibration long, and performing a NOP command.
